(19) United States
(12) Patent Application Publication
(10) Pub. No.: US 2012/0105789 A1
(43) Pub. Date: May 3, 2012

(54) DISPLAY SUBSTRATE HAVING APERIODICALLY ARRANGED SPACERS

(76) Inventors: Chih-Wei LIN, Taichung City (TW); Min-Cheng Wang, Taipei County (TW); Yu-Lun Hsueh, Taoyuan County (TW)

(21) Appl. No.: 13/008,474

(22) Filed: Jan. 18, 2011

(30) Foreign Application Priority Data
Oct. 29, 2010 (TW) 099220981

(51) Int. Cl. G02F 1/1339

(52) U.S. Cl. 349/155

(57) ABSTRACT

A display substrate includes a plate and a plurality of spacers. The plate has a plate surface, and the plate surface is divided into a central region and a peripheral region, wherein the peripheral region surrounds the central region. The spacers are disposed on the plate surface in an aperiodic arrangement manner. A number of the spacers located in the central region is M, and a number of the spacers located in the peripheral region is N. An area of the central region is X, and an area of the peripheral region is Y. X, Y, M, and N satisfy the following mathematical expression:

$$\frac{M}{X} \geq \frac{N}{Y} .$$

### CROSS-REFERENCE TO RELATED APPLICATIONS

This application claims the benefit of Taiwan Patent Application No. 099220981, filed on Oct. 29, 2010, which is hereby incorporated by reference for all purposes as if fully set forth herein.

### BACKGROUND OF THE INVENTION

1. Field of Invention

The present invention relates to a display, and more particularly to a display substrate having aperiodically arranged spacers.

2. Related Art

The current liquid crystal display (LCD) panel generally includes an active component array substrate, a color filter substrate, and a liquid crystal material, in which the liquid crystal material is filled between the active component array substrate and the color filter substrate and is a liquid material, so that the liquid crystal material has fluidity.

Due to the fluidity of the liquid crystal material, after the liquid crystal material is filled between the active component array substrate and the color filter substrate, the active component array substrate and the color filter substrate must be kept in a separated status; otherwise, the active component array substrate and the color filter substrate press the liquid crystal material, leading to a leakage of the liquid crystal material.

### SUMMARY OF THE INVENTION

The present invention is directed to a display substrate having aperiodically arranged spacers, which includes a plurality of spacers, and the spacers are used for keeping an active component array substrate and a color filter substrate in a separated status, so as to prevent a leakage of a liquid crystal material.

The present invention provides a display substrate including a plate and a plurality of spacers. The plate has a plate surface, and the plate surface is divided into a central region and a peripheral region, wherein the peripheral region surrounds the central region. The spacers are disposed on the plate surface in an aperiodic arrangement manner. A number of the spacers located in the central region is M, and a number of the spacers located in the peripheral region is N. An area of the central region is X, and an area of the peripheral region is Y. X, Y, M, and N satisfy the following mathematical expression:

$$\frac{M}{X} \geq \frac{N}{Y} .$$

Based on the above, the present invention can keep the active component array substrate and the color filter substrate in a separated status through the spacers, and prevent the liquid crystal material filled between the two substrates from leakage when the liquid crystal material is pressed by the plates

To make the above features and advantages of the present invention comprehensible, embodiments will be described in detail below with reference to the accompanying drawings.

### BRIEF DESCRIPTION OF THE DRAWINGS

The present invention will become more fully understood from the detailed description given herein below for illustration only, and thus are not limitative of the present invention, and wherein:

FIG. 1A is a schematic top view of a display substrate having aperiodically arranged spacers according to an embodiment of the present invention; and

FIG. 1B is a schematic sectional view along line I-I in FIG. 1A.

### DETAILED DESCRIPTION OF THE INVENTION

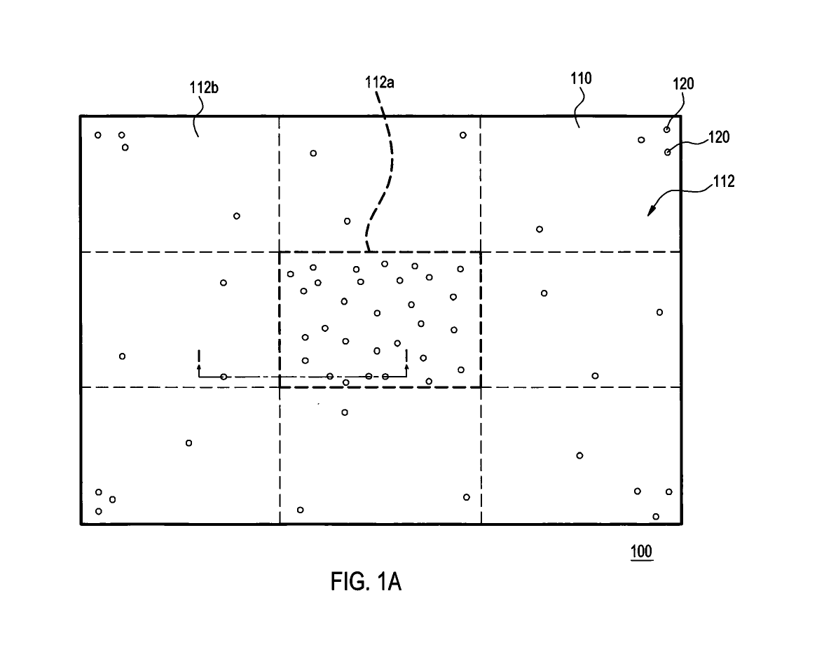

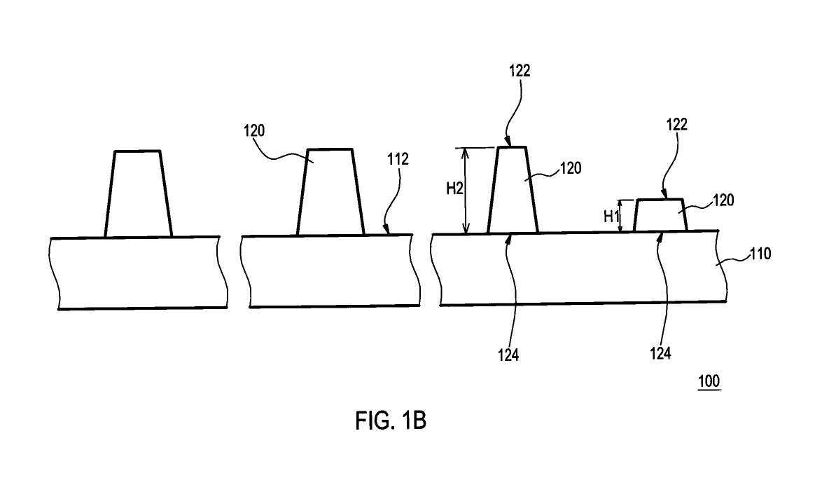

FIG. 1A is a schematic top view of a display substrate having aperiodically arranged spacers according to an embodiment of the present invention. Referring to FIG. 1A, the display substrate 100 is applicable to an LCD, and includes a plate 110 and a plurality of spacers 120 all disposed on the plate 110. The spacers 120 are, for example, a plurality of photo spacers, and thus the material of the spacers 120 may be photoresists.

The plate 110 may be a color filter substrate or an active component array substrate and has a plate surface 112. The spacers 120 are all disposed on the plate surface 112, that is, the spacers 120 are all located on the same side of the plate 110. The plate surface 112 is divided into a central region 112a and a peripheral region 112b, in which the peripheral region 112b surrounds the central region 112a. Some spacers 120 are located in the peripheral region 112b, and the other spacers 120 are located in the central region 112a.

The spacers 120 are disposed on the plate surface 112 in an aperiodic arrangement manner. Specifically, from the perspective of the entire plate surface 112, the distribution of all the spacers 120 on the plate surface 112 does not follow any order or period. In other words, the spacers 120 may be disposed on the plate surface 112 in a chaos or random arrangement manner. In addition, all the spacers 120 are not necessarily uniformly distributed on the plate surface 112. For example, as shown in FIG. 1A, the distribution of the spacers 120 on the plate surface 112 is obviously not uniform.

A number of the spacers 120 located in the central region 112a may be M, and a number of the spacers 120 located in the peripheral region 112b may be N. Therefore, both M and N are natural numbers. In addition, M and N may satisfy a condition that M≧N, that is, the number of the spacers 120 located in the central region 112a is larger than or equal to the number of the spacers 120 located in the peripheral region 112b. Taking FIG. 1A for example, the number of the spacers 120 located in the peripheral region 112b is 28, and the number of the spacers 120 located in the central region 112a is 30, thereby the condition: M≧N satisfied.

However, it should be noted that in other embodiments, M and N may also satisfy a condition that N≧M. Therefore, the number of the spacers 120 located in the central region 112a and the number of the spacers 120 located in the peripheral region 112b in FIG. 1A are only exemplary and do not limit the present invention.

An area of the central region 112a is X, and an area of the peripheral region 112b is Y. Therefore, both X and Y are larger than zero. X and Y may satisfy a condition that Y≧X, that is, the area of the peripheral region 112b is larger than the area of the central region 112a. Taking FIG. 1A for example, the plate surface 112 is substantially rectangular and equally divided into nine-square grids. The central region 112a is a grid in the center, and the remaining grids form the peripheral region 112b, so that a ratio between the area of the peripheral region 112b and the area of the central region 112a is substantially 8:1, that is, the value of the ratio between Y and X is substantially equal to 8.

However, the area of the peripheral region 112b may also be smaller than the area of the central region 112a. For example, the plate surface 112 may also be divided in other manners. For instance, the plate surface 112 is equally divided into grids of 4×4 or 5×5 matrix arrangement. Therefore, the areas and the ratios both of the central region 112a and the peripheral region 112b as shown in FIG. 1A are only exemplary, and do not limit the present invention.

It should be noted that in this embodiment, the arrangement of the spacers 120 may be applied to a touch panel, and thus the above X, Y, M, and N may further satisfy the following mathematical expression (1):

$$\frac{M}{X} \geq \frac{N}{Y} \qquad ( 1 )$$

It can be seen from the mathematical expression (1) that the number of the spacers 120 in per unit area of the central region 112a is larger than or equal to the number of the spacers 120 in a unit area of the peripheral region 112b. That is, a distribution density of the spacers 120 in the central region 112a is larger than or equal to a distribution density of the spacers 120 in the peripheral region 112b. Therefore, the distribution of the spacers 120 in the central region 112a is denser than the distribution of the spacers 120 in the peripheral region 112b, so as to match the requirement that more touches occur in the central region of the touch panel, as shown in FIG. 1A.

FIG. 1B is a schematic sectional view along line I-I in FIG. 1A. Referring to FIG. 1B, the shape of the spacer 120 may substantially be a column, and each spacer 120 has a top surface 122 and a bottom surface 124. The top surface 122 is opposite to the bottom surface 124, and the bottom surface 124 may contact the plate surface 112. In addition, each spacer 120 may gradually narrow from the bottom surface 124 to the top surface 122, as shown in FIG. 1B.

The shape of the spacers 120 may be all the same, or not all the same, and thus the shape of one spacer 120 may be different from the shape of another spacer 120. For example, in FIG. 1B, it can be clearly seen that an area of the top surface 122 of one spacer 120 (such as the second spacer 120 from the right) is smaller than an area of the top surface 122 of another spacer 120 (such as the rightmost spacer 120).

In addition, the height of the spacers 120 may also be different. Taking FIG. 1B for example, the height H1 of one spacer 120 (such as the rightmost spacer 120) is smaller than the height H2 of another spacer 120 (such as the second spacer 120 from the right).

In conclusion, the spacers in the display substrate according to the present invention can be served as supporting members between one plate (such as a active component array substrate) and another plate (such as a color filter substrate), so that the two plates are kept in a separated status. In this manner, a gap is maintained between the two plates, so as to prevent the liquid crystal material filled in the gap from leakage when the liquid crystal material is pressed by the plates.

In addition, the distribution of the spacers in the central region is denser than the distribution of the spacers in the peripheral region, and the number of the spacers located in the central region is larger than or equal to the number of the spacers located in the peripheral region, so that the present invention enhances the resistance to pressure and the recovering ability after pressing the central portion of the LCD panel under a condition of a limited number of spacers, and meanwhile avoids the insufficient liquid crystal material.

In this manner, when the LCD panel is in a low temperature environment (below 0° C.), the present invention can reduce the probability that vacuum bubbles occur due to cold shrinkage of the liquid crystal material.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A display substrate having aperiodically arranged spacers, comprising:
a plate, having a plate surface, wherein the plate surface is divided into a central region and a peripheral region, and the peripheral region surrounds the central region; and
a plurality of spacers, disposed on the plate surface in an aperiodic arrangement manner, wherein a number of the spacers located in the central region is M, and a number of the spacers located in the peripheral region is N; an area of the central region is X, and an area of the peripheral region is Y, wherein X, Y, M, and N satisfy the following mathematical expression:
$$\frac{M}{X} \geq \frac{N}{Y} .$$

2. The display substrate having aperiodically arranged spacers according to claim 1, wherein a shape of the spacer is substantially a column.

3. The display substrate having aperiodically arranged spacers according to claim 2, wherein each spacer has a top surface and a bottom surface; the top surface is opposite to the bottom surface, and the bottom surface contacts the plate surface; and each spacer gradually narrows from the bottom surface to the top surface.

4. The display substrate having aperiodically arranged spacers according to claim 3, wherein an area of the top surface of one spacer is smaller than an area of the top surface of another spacer.

5. The display substrate having aperiodically arranged spacers according to claim 2, wherein a height of one spacer is smaller than a height of another spacer.

6. The display substrate having aperiodically arranged spacers according to claim 1, wherein the spacers are a plurality of photo spacers.

7. The display substrate having aperiodically arranged spacers according to claim 1, wherein the plate is a color filter substrate.

8. The display substrate having aperiodically arranged spacers according to claim 1, wherein the plate is an active component array substrate.

9. The display substrate having aperiodically arranged spacers according to claim 1, wherein M≧N.

10. The display substrate having aperiodically arranged spacers according to claim 1, wherein Y≧X.

11. The display substrate having aperiodically arranged spacers according to claim 10, wherein a value of a ratio between Y and X is substantially equal to 8.
